(19) United States
(12) Patent Application Publication
(10) Pub. No.: US 2014/0108568 A1
(43) Pub. Date: Apr. 17, 2014

(54) Method and System for Providing Multimedia Content Sharing Service While Conducting Communication Service

(71) Applicant: Gil-soo Lee, Gyeonggi-do (KR)

(72) Inventor: Gil-soo Lee, Gyeonggi-do (KR)

(73) Assignee: TI SQUARE TECHNOLOGY LTD., Gyeonggi-do (KR)

(21) Appl. No.: 14/008,548

(22) PCT Filed: Mar. 27, 2012
(86) PCT No.: PCT/KR12/02228

§ 371 Date: Dec. 6, 2013

(30) Foreign Application Priority Data
Mar. 29, 2011 (KR) 10-2011-0028276
Jun. 27, 2011 (KR) 10-2011-0062173

(51) Int. Cl. H04L 29/06; H04L 12/58

(52) U.S. Cl. CPC H04L 65/1083; H04L 51/10
USPC 709/206; 709/227; 709/219

(57) ABSTRACT

The present invention relates to a system and a method for providing a service for providing multimedia content, such as music and movies, to a client terminal while conducting a communication service based on an Internet protocol, such as text chatting, voice calling, video calling, video chatting, so that users on both sides can simultaneously use the multimedia content. The method for providing a multimedia content sharing service is for providing the multimedia content sharing service, by a service provision system for providing a communication service between a first terminal and a second terminal, to the first terminal and the second terminal while conducting the communication service, and comprises: a first step of receiving from the first terminal a request signal for the multimedia content sharing service with the second terminal; a second step of forming a session for transmitting the multimedia content between the first terminal and the second terminal, according to the multimedia content sharing request signal; a third step of receiving a multimedia content data, which corresponds to the multimedia content that is transmitted from the first terminal, and transmitting same to the second terminal; a fourth step of receiving from the first terminal a play indication signal for indicating the playing of the multimedia content and transmitting same to the second terminal; and a fifth step of receiving from the second terminal a reply signal to the play indication signal and transmitting same to the first terminal, wherein the first terminal and the second terminal plays the multimedia content based on the play indication signal.

### TECHNICAL FIELD

The present invention relates, in general, to a method and system for providing a multimedia content sharing service while performing a communication service and, more particularly, to a service provision system and method which can smoothly provide multimedia content, such as music, movies, or electronic books (c-books), to a client terminal while performing a communication service, such as text chat, voice call, video call, voice chat, or video chat services, based on Internet protocols.

### BACKGROUND ART

Recently, with the development of Internet technology, mobile communication terminals equipped with an Internet protocol-based network access function, such as smart phones, tablet Personal Computers (PCs), or smart televisions (TVs), have been rapidly popularized, and research into and the development of various types of communication services using such mobile communication terminals have been made using various methods.

Such a mobile communication terminal is configured to enable the use of various types of communication services, such as services for a voice call, a chat during a voice call, a voice chat, a text chat, a messaging service, a video call, or a video chat, through a Wireless Local Area Network (WLAN) such as a WiFi network, instead of an existing 2nd or 3rd Generation (2G or 3G) mobile communication network. A communication service using a WLAN has been widely used in that users do not pay separate fees. Recently, the number of so-called Mobile Voice over Internet Protocol (mVoIP) services for providing voice call services based on the Internet Protocol (IP) has greatly increased.

In accordance with this trend, there are required schemes capable of conveniently and smoothly providing multimedia content, such as music, movies, or c-books, together with various types of communication services, such as voice call, voice chat, text chat, voice or video message transfer, video call, or video chat services, to users based on IP.

### DISCLOSURE

### Technical Problem

The present invention has been made keeping in mind the above problems, and an object of the present invention is to provide a service provision method and system, which allow users to conveniently share multimedia content, such as music, movies, or e-books while performing various types of communication services, such as services for a voice call, a chat during a voice call, a text chat, a video call, or a video chat.

Another object of the present invention is to provide a service provision method and system, which allow communication service users to simultaneously listen to or view the corresponding multimedia content that is automatically provided when a service subscriber selects music, movies, e-books, or various Video On Demand (VOD) files desired to be listened to or viewed together with another party in a menu provided by an application installed on his or her smart terminal while performing a real-time communication service between smart terminals, or is automatically provided based on a specific keyword entered during chatting.

A further object of the present invention is to provide a service provision system and method, which have a ‘gift function’ allowing a service subscriber to present the corresponding multimedia content as a gift to another party by selecting music, VOD or movie information currently being played while simultaneously performing a communication service between smart terminals and utilizing multimedia content in real time, or a ‘buy/purchase function’ allowing a service subscriber to store the corresponding content in his or her terminal by selecting ‘purchase’.

Yet another object of the present invention is to provide a service provision system and method, which can provide a micro-payment interworking function that uses the phone number of a mobile communication terminal to pay for the gift or purchase of the corresponding multimedia content while simultaneously performing a communication service between smart terminals and listening to or viewing multimedia content in real time, a payment function that is based on interworking with streaming or download services, or sound source download services which use interworking with existing music/VOD, movie sites, or clouding systems, or an online payment function that is based on interworking with open markets, such as application (App) stores, or virtual stores.

Still another object of the present invention is to provide a service provision system and method, which can provide a service interworking function based on applications installed on a smart terminal, thus providing a multimedia content sharing service so that interworking between networks can be smoothly performed while a communication service between a smart terminal and an existing legacy 2G/3G network-based terminal is performed.

### Technical Solution

In order to accomplish the above objects, the present invention provides a method of providing a multimedia service while performing a communication service, including allowing at least one of a transmitting terminal and a receiving terminal to select whether to play multimedia content while performing a communication service between the transmitting terminal and the receiving terminal; mixing the selected multimedia content with audio or video data and transmitting mixed data to a terminal of another party while playing the selected multimedia content; and playing received mixed data on the terminal of the other party.

In accordance with another aspect of the present invention, there is provided a method of providing a multimedia service while performing a communication service, comprising allowing at least one of a transmitting terminal and a receiving terminal to select multimedia content to be transmitted to a terminal of another party while performing a communication service between the transmitting terminal and the receiving terminal service; establishing a transfer session required to transmit the selected multimedia content to the terminal of the other party; transmitting multimedia content data to the terminal of the other party through the transfer session; and playing the received multimedia content data on the terminal of the other party.

In this case, by a selection menu of the transmitting terminal or the receiving terminal, the transmission, play, streaming, purchase or gift menu of the multimedia content may be provided.

A method of providing a multimedia content sharing service according to an aspect of the present invention is a method configured such that a service provision system for providing a communication service between a first terminal and a second terminal provides a multimedia content sharing service to the first terminal and the second terminal while performing a communication service, and includes a first step of receiving a signal requesting sharing of multimedia content with the second terminal from the first terminal while performing a communication service; a second step of establishing a session for transfer of multimedia content between the first terminal and the second terminal in response to the multimedia content sharing request signal; a third step of receiving multimedia content data corresponding to multimedia content transmitted from the first terminal and transmitting the multimedia content data to the second terminal; a fourth step of receiving a play direction signal directing play of the multimedia content from the first terminal and transmitting the play direction signal to the second terminal; and a fifth step of receiving a response signal to the play direction signal from the second terminal and transferring the response signal to the first terminal. In this case, the first terminal and the second terminal may play the multimedia content in response to the play direction signal.

In an embodiment, the multimedia content sharing request signal may be generated when multimedia content included in a menu page provided by an interface of a communication service of the first terminal is selected by the first terminal.

In an embodiment, the multimedia content sharing request signal may be generated when multimedia content retrieved based on text data input from the first terminal is selected by the first terminal while the communication service is performed.

In an embodiment, the play direction signal may include information about time at which play of the multimedia content is to be started, and the first terminal and the second terminal simultaneously and individually play the multimedia content at a time corresponding to the time information.

In an embodiment, the second terminal may start to play the multimedia content in response to reception of the play direction signal at the fourth step, and the first terminal starts to play the multimedia content in response to reception of a response signal to the play direction signal at the fifth step.

In an embodiment, the service provision method may further include, after the fifth step, a sixth step of receiving a multimedia content play control signal from the first terminal and transmitting the multimedia content play control signal to the second terminal. In this case, the second terminal may perform control related to play of the multimedia content in response to the multimedia content play control signal.

In an embodiment, the multimedia content play control signal may include a control signal required to control at least one of play, stop, repetitive play, forward movement, backward movement, and volume level control operations of the multimedia content.

In an embodiment, the third step may include receiving a Message Session Relay Protocol (MSRP) SEND message containing the multimedia content data from the first terminal and sending the MSRP SEND message to the second terminal.

In an embodiment, the fourth step may include sending a Session Initiation Protocol (SIP) to message containing a play command for the multimedia content data to the second terminal.

A system for providing a multimedia content sharing service according to an aspect of the present invention is a system being a service provision system for providing a communication service between a first terminal and a second terminal and providing the multimedia content sharing service to the first terminal and the second terminal while performing a communication service, and includes a signal processing server for receiving a signal requesting sharing of multimedia content with the second terminal from the first terminal while performing a communication service, and for establishing a session for transfer of multimedia content between the first terminal and the second terminal in response to the multimedia content sharing request signal; and a multimedia content relay server for receiving multimedia content data corresponding to the multimedia content transmitted from the first terminal, and transmitting the multimedia content data to the second terminal In this case, the signal processing server may receive a play direction signal directing play of the multimedia content from the first terminal, transmit the play direction signal to the second terminal, receive a response signal acknowledging reception of the play direction signal from the second terminal, and transmit the response signal to the first terminal, and the first terminal and the second terminal may play the multimedia content in response to the play direction signal.

A method of providing a multimedia content sharing service according to another aspect of the present invention is a method configured such that a service provision system for providing a communication service between a first terminal and a second terminal provides a multimedia content sharing service to the first terminal and the second terminal while performing a communication service, and includes a first step of receiving a signal requesting sharing of multimedia content with a second terminal from a first terminal while performing a communication service; a second step of transmitting a signal, required to determine whether to share multimedia content, to the second terminal in response to the multimedia content sharing request signal, receiving a response signal to the transmitted signal, and transferring the response signal to the first terminal; a third step of receiving identification information of multimedia content desired to be played and a content sharing information transmission request signal from the first terminal; a fourth step of extracting multimedia content connection information corresponding to the content identification information and transmitting the multimedia content connection information to the second terminal; and a fifth step of transmitting the multimedia content to the first terminal and the second terminal connected to each other based on the multimedia content connection information in a streaming manner.

In an embodiment, the multimedia content sharing request signal may be generated when multimedia content included in a menu page provided by an interface of a communication service of the first terminal is selected by the first terminal.

In an embodiment, the multimedia content sharing request signal may be generated when multimedia content retrieved based on text data input from the first terminal is selected by the first terminal while the communication service is performed.

In an embodiment, the multimedia content sharing request signal may include a request message querying the second terminal about whether to receive the multimedia content in a streaming manner.

In an embodiment, the content sharing service provision method may further include, after the fifth step, receiving a gift request signal requesting another party or a third party to transmit the multimedia content from at least one of the first terminal and the second terminal and transmitting the multimedia content to the other party or the third party depending on payment made by at least one of the first terminal and the second terminal.

In an embodiment, the multimedia content sharing service provision method may further include, after the fifth step, receiving a download request signal required to download the multimedia content to its own terminal from at least one of the first terminal and the second terminal, and transmitting the multimedia content to the corresponding terminal depending on payment made by at least one of the first terminal and the second terminal.

In an embodiment, the multimedia content sharing service provision method may further include, after the fifth step, receiving a multimedia content play control signal from any one of the first terminal and the second terminal and transmitting the multimedia content play control signal to a remaining one of the first terminal and the second terminal. In this case, the remaining one of the first terminal and the second terminal may perform control related to play of the multimedia content in response to the multimedia content play control signal.

In an embodiment, the multimedia content play control signal may be a control signal required to control at least one of play, stop, repetitive play, forward movement, backward movement, and volume level control operations of the multimedia content.

A system for providing a multimedia content sharing service according to another aspect of the present invention is a service provision system for providing a communication service between a first terminal and a second terminal and providing the multimedia content sharing service to the first terminal and the second terminal while performing a communication service, and includes a signal processing server for, as a signal requesting sharing of multimedia content with the second terminal is received from the first terminal while performing a communication service, transmitting a signal required to determine whether to share multimedia content to the second terminal, receiving a response signal to the transmitted signal, transmitting the response signal to the first terminal, and receiving identification information of multimedia content desired to be played and a multimedia content play request signal from the first terminal; a content management server for extracting multimedia content data corresponding to the identification information at a request of the signal processing server; and a streaming server for transmitting the multimedia content data received from the content management server to the first terminal and the second terminal in a streaming manner at a request of the signal processing server.

A method of providing a multimedia content sharing service according to a further aspect of the prevent invention is a method configured such that at least one of a first terminal and a second terminal provides multimedia content while performing a communication service between the first terminal and the second terminal, via a service provision system for providing a communication service including a real-time text or video chat service, and includes a first step of automatically detecting a preset keyword in real time from messages sent/received through a text chat or a video chat on a user terminal while performing a communication service; a second step of automatically extracting multimedia content data corresponding to the keyword in real time; and a third step of transmitting video data obtained by mixing or overlaying the multimedia content data with or on signals of the text chat or the video chat to a terminal of another party engaged in the text chat or the video chat.

A method of providing a multimedia content sharing service according to yet another aspect of the present invention is a method configured such that at least one of a first terminal and a second terminal provides multimedia content while performing a communication service between the first terminal and the second terminal, via a service provision system for providing a communication service including a real-time text or video chat service, and includes a first step of automatically detecting a preset keyword in real time from messages sent/received through a text chat or a video chat on a user terminal while performing a communication service; a second step of transmitting signals of the text chat or the video chat and the keyword to a terminal of another party engaged in the text chat or the video chat in real time; and a third step of allowing the terminal of the other party to extract multimedia content data corresponding to the keyword, and displaying video data, obtained by mixing the extracted multimedia content data with the text chat or video chat signals, on a screen.

A method of providing a multimedia content sharing service according to still another aspect of the present invention is a method configured such that at least one of a first terminal and a second terminal provides multimedia content while performing a communication service between the first terminal and the second terminal, via a service provision system for providing a communication service including a real-time text or video chat service, and includes a first step of playing a specific sound source or a Video On Demand (VOD) file on a user terminal while performing a communication service; a second step of mixing audio data of the sound source or the VOD file at the first step with audio data of a user input through a microphone of the user terminal; and a third step of transmitting mixed audio signals to a terminal of another party engaged in the communication service. In this case, the user terminal mixes the audio data of the sound source or the VOD file with audio data received from the terminal of the other party and outputs mixed audio data through a speaker, and the terminal of the other party outputs mixed audio signals received from the user terminal through a speaker.

### Advantageous Effects

According to the present invention, there can be provided a service provision method and system, which allow all of communication service users to simultaneously and conveniently use multimedia content, such as music, movies, or e-books while performing various types of communication services, such as services for a voice call, a voice chat, that is, a chat during a voice call, a text chat, voice or video message transfer, a video call, or a video chat.

For example, a subscriber (customer) who subscribed to the service of the present invention to may listen to or watch or view the corresponding multimedia content either simultaneously with another party or together with another party by selecting music (MP3), a movie, a book (e-book), or various types of VOD files desired to be enjoyed with the other party either by using a menu provided by a predetermined application installed on his or her terminal or by using a specific keyword (for example, the name of a singer, a song title, a composer, or the like in the case of songs, a book title or an author in the case of books, and a movie title, the name of a main character, the name of a movie director, or the like in the case of movie-related information) entered during chatting, while performing a service, such as a real-time text chat service, a chat service during a voice call, or a video chat service, between smart terminals.

Further, according to the present invention, there can be provided a service, which allows a user on a media playing side to present the corresponding content as a gift to another party by clicking or touching information about music, a VOD file, or a movie currently being played while the users of a communication service are listening to music or viewing a VOD file together with each other when a real-time communication service is performed between smart terminals, and which allows a user on at least a receiving side to store the corresponding content in his or her terminal or the like by selecting the purchase of the corresponding music, VOD file or movie. In particular, the present invention may induce businesses associated with various types of other businesses by providing a service enabling a gift to be presented to a third party.

Furthermore, according to the present invention, there is the advantage of providing payment services, such as a micro-payment service that uses the phone number of a mobile communication terminal to utilize a payment service for the corresponding content while predetermined multimedia content is simultaneously listened to or viewed in real time when a text chat, a chat during a voice call, or a video chat is performed between smart terminals, a payment service that is based on service interworking, such as for streaming or sound source uploading/downloading based on interworking with existing music, VOD or movie sites, or clouding systems, or an online payment service that is based on interworking with open markets or virtual stores, thus expanding the targets of charged services for multimedia content by means of such payment services.

Furthermore, according to the present invention, an interworking service function is provided which connects the application of a transmitting smart terminal to the customer of an existing legacy network upon performing a communication service between a smart terminal and an existing legacy 2G/3G network-based terminal, thus enabling a real-time multimedia content sharing service to be smoothly provided upon performing a communication service between different types of networks.

### DESCRIPTION OF DRAWINGS

FIG. 1 is a schematic conceptual diagram showing a system for providing a multimedia content sharing service while performing a communication service according to an embodiment of the present invention;

FIG. 2 is a schematic block diagram showing an embodiment of a configuration employable in the multimedia content sharing service provision system of FIG. 1;

FIG. 3 is a flowchart showing a service procedure for a multimedia content sharing service provision method employable in the multimedia content sharing service provision system of FIG. 2;

FIG. 4 is a diagram showing a process for listening to and transmitting in real time a music file selected by a user terminal during a video chat between the user terminals of FIG. 1;

FIG. 5 is a diagram showing a process for playing and transmitting in real time a VOD file selected by a user terminal during video chatting between user terminals of FIG. 1;

FIG. 6 is a schematic block diagram showing another embodiment of a configuration employable in the multimedia content sharing service provision system of FIG. 1;

FIG. 7 is a flowchart showing a service procedure for a multimedia content sharing service provision method employable in the multimedia content sharing service provision system of FIG. 6;

FIG. 8 is a schematic block diagram showing a further embodiment of a configuration employable in the multimedia content sharing service provision system of FIG. 1;

FIG. 9 is a conceptual diagram showing an interworking procedure for a client terminal employable in the system and method according to an embodiment of the present invention;

FIG. 10 is a conceptual diagram showing a gift supplementary service procedure employable in the system and method according to an embodiment of the present invention;

FIG. 11 is a conceptual diagram showing a downloading supplementary service procedure employable in the system and method according to an embodiment of the present invention;

FIG. 12 is a conceptual diagram showing another embodiment of a multimedia sharing service employable in the system and method according to the embodiment of the present invention; and

FIG. 13 is a conceptual diagram showing a further embodiment of a multimedia sharing service employable in the system and method according to the embodiment of the present invention.

### BEST MODE

Hereinafter, embodiments of the present invention will be described in detail with reference to the attached drawings

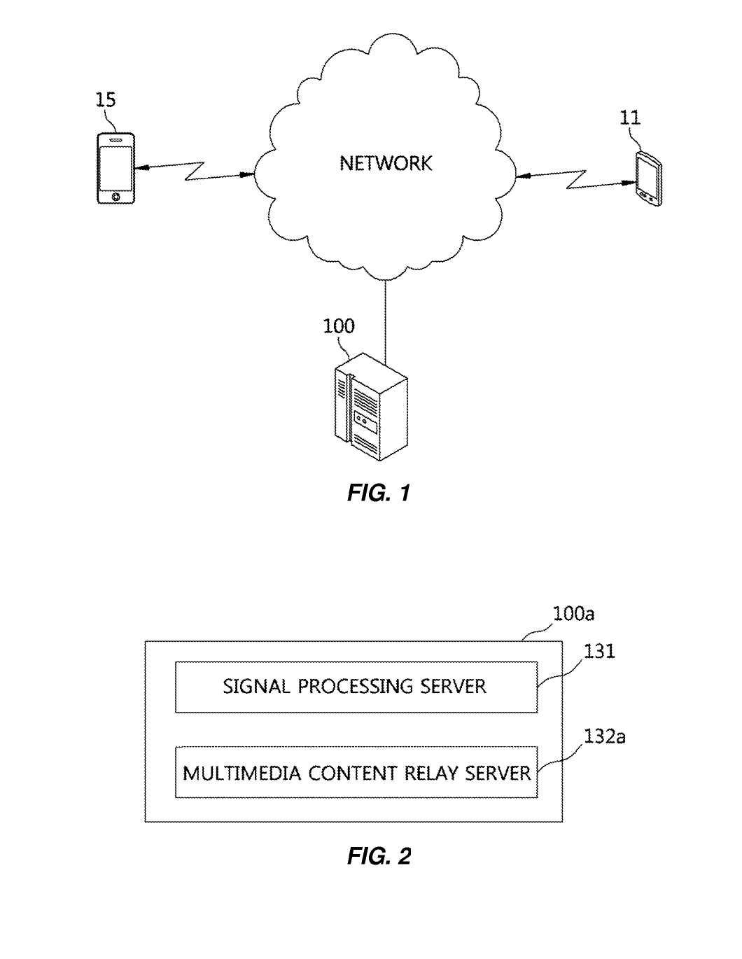

FIG. 1 is a schematic conceptual diagram showing a system for providing a multimedia content sharing service while performing a communication service according to an embodiment of the present invention.

Referring to FIG. 1, a system 100 for providing a multimedia content sharing service (hereinafter simply referred to as a ‘service provision system’) is connected to a network and is configured to provide a service to users who use a communication service so that the users can share multimedia content while performing the communication service.

A communication service may be a call or communication service corresponding to at least one of voice call, voice chat, text chat, video call, video chat, and message transfer services.

Multimedia content includes all of audio data- or video data-format music, movies, e-books, etc. which can be transmitted over a network.

The sharing of multimedia content denotes the function of providing multimedia content to at least one transmitting terminal and at least one receiving terminal using a scheme for mixing images and transmitting mixed images to the terminal of another party, a file transfer scheme, or a streaming transmission scheme, and then allowing the users of the transmitting terminal and the receiving terminal to substantially simultaneously listen to or watch or view the corresponding content.

A network includes all types of networks capable of performing a call or communication function, such as a network for wired or wireless voice communication, a network for a wired or wireless video call, an Internet Protocol (IP)-based communication network, or the Internet. Such a network may include a wireless communication network, a data network, or a satellite network, wherein wireless communication networks may be classified into, for example, a Body Area Network (BAN), a Personal Area Network (PAN), a Local Area Network (LAN), a Metropolitan Area Network (MAN), a Wide Area Network (WAN), etc. according to the transmission distance thereof.

At least two user terminals 11 and 15 to be coupled to heterogeneous networks or homogeneous networks are connected to the network, and each of the user terminals may be a transmitting terminal or a receiving terminal Each of the user terminals 11 and 15 may be a voice telephone for a voice call, a video phone for a video call, a smart phone for data communication, a tablet PC, or a smart terminal such as a smart television (TV). A smart terminal may be configured such that a wireless LAN processing unit for performing data communication in an indoor environment, a cellular-based WAN processing unit for performing a voice call or data transmission/reception, a wireless communication processing unit for receiving Global Positioning System (GPS) signals required to determine location information, etc. are installed in the smart terminal.

The service provision system 100 according to the present embodiment is configured such that selected multimedia content may be simultaneously used by the users of the transmitting terminal and the receiving terminal by allowing the user of the transmitting terminal or the receiving terminal to generate a multimedia content sharing service request signal using the menu of an application for providing a communication service while performing the communication service, without at least two user terminals on the network having to terminate the communication service or execute a separate application (for example, a file transmission program or the like).

For example, when a son making a video call to his father selects multimedia content corresponding to a song desired to be sung together with his father from his terminal, the service provision system may provide a service so that the son and the father can listen to the song, mixed with video call data, as background music together while making the video call, by transmitting the corresponding song file stored in the terminal of the son to the terminal of the father or by transmitting multimedia content data corresponding to the song to the terminals of the son and the father in a streaming manner.

In another example, when a daughter who is studying with an e-book calls her mother and makes a voice or video call so as to ask her about specific content of the e-book, and selects a multimedia content sharing menu provided by a predetermined application installed on the terminal of the daughter, the service provision system may provide a service so that the daughter and the mother speak with each other while viewing together the same c-book, by receiving the corresponding e-book from the terminal of the daughter and transmitting it to the terminal of the mother, or by allowing the service provision system to provide multimedia content corresponding to a webpage-format document produced using an Active Server Page (ASP), an eXtended Markup Language (XML), flash, or a HyperText Transfer Protocol (HTTP), to the terminals of the daughter and the mother in real time. In this case, the application may provide the most part of the screen of each of the terminals of the daughter and the mother as an e-book display area and provide a portion of the screen as an area for displaying a video call screen or a menu provided by an application.

In this case, the application denotes a mobile application, which is a module operating in an application layer located at a highest level from the standpoint of the architecture of a terminal or a network. That is, a mobile application is a module for allowing the user to personally control activation/deactivation and providing functions, such as call, information acquisition, and entertainment functions, from the standpoint of the user, and may function as an entity capable of providing a specific service, for example, the multimedia content sharing service of the present embodiment, to the user or capable of charging the user for the service according to the corresponding application, from the standpoint of a service provider. In the present embodiment, the application may be implemented using one or more applications for providing all of a communication service, a multimedia content sharing service, and supplementary services of the multimedia content sharing service to the user terminal or providing at least one of the multimedia content sharing service and supplementary services to the user terminal. Such an application is configured to allow the user to easily use the service provided by the service provision system while working in conjunction with the service provision system over the network, and may be implemented to have various forms and configurations depending on the type or shape of the terminal, the type or version of an operating system installed on the terminal, the kind of development language, or the like.

FIG. 2 is a schematic block diagram showing an embodiment of a configuration employable in the multimedia content sharing service provision system of FIG. 1.

Referring to FIG. 2, a service provision system 100a includes a signal processing server 131 and a multimedia content relay server 132a.

The signal processing server 131 identifies whether a user terminal desiring to perform a communication service over a network is that of a subscriber to or a customer of the multimedia content sharing service, and executes a scenario required to provide the multimedia content sharing service in response to a service request signal from the user terminal.

For example, the signal processing server 131 may receive a multimedia content sharing request signal from a transmitting or receiving terminal while performing a communication service, and establish a session for transferring multimedia content data between the corresponding terminals in response to the request signal.

The multimedia content relay server 132a transfers a multimedia file corresponding to multimedia content from one side user terminal to the other side user terminal via the file transfer session established by the signal processing server 131 so that a plurality of terminals can simultaneously share multimedia content while performing the communication service.

The service provision system 100a according to the present embodiment may include a Registration Server (RS) to register subscribers to the multimedia content sharing service or authenticate the subscribers when performing the communication service between the first terminal and the second terminal.

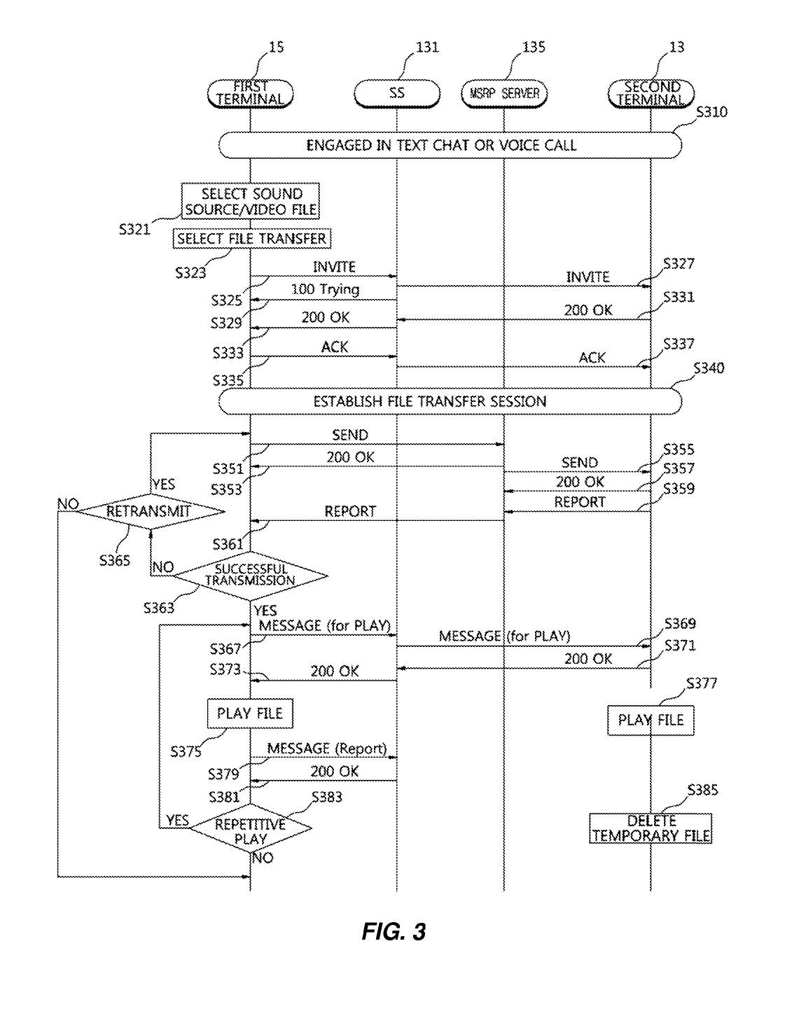

FIG. 3 is a flowchart showing a service procedure for a multimedia content sharing service provision method employable in the multimedia content sharing service provision system of FIG. 2.

As shown in FIG. 3, the multimedia content sharing service provision method is configured such that the service provision system including the signal processing server 131 and the multimedia content relay server 132a establishes a file transfer session between user terminals, which perform a communication service, in response to a multimedia content sharing request signal received from at least one of the user terminals, thus enabling the corresponding content to be shared between the user terminals.

In the present embodiment, the service provision system includes a Signaling Server (SS) as the signal processing server 131, and a relay server as the multimedia content relay server 132a. The relay server may include a Message Session Relay Protocol (MSRP) server 135. An MSRP may be used to perform functions or operations, such as instant messaging (IM) that is a communication form based on Rich Communication Suite (RCS) content applied to the use of an IP Multimedia Subsystem (IMS) for providing a mobile telecommunication service, in particular, based on real-time direct text, file transfer for transferring a file through a computer network or the Internet, or image sharing for supporting image sharing between users during a mobile phone call.

The procedure of the multimedia content sharing service provision method according to the present embodiment will be described in detail below.

First, while users are engaged in a communication service corresponding to any one of a voice call, a voice mail, instant messaging, a video call, a video chat, and combinations thereof via an IP-based multimedia service session established between a first terminal 15 and a second terminal 13 (S310), the user of the first terminal 15 selects a sound source or a video file desired to be listened to or viewed together with the user of the second terminal 13 through a predetermined application installed on the terminal (S321), and selects file transfer for the selected file (S323).

Depending on the user's selection, the application of the first terminal 15 requests the service provision system to share multimedia content and transmits a signal required to invite the second terminal 13 to the multimedia content sharing service to the SS 131 of the service provision system (S325). For example, when the user selects specific multimedia content from a menu page provided by the interface of the communication service of the first terminal 15, the multimedia content sharing request signal may be generated in the form of an INVITE message in which MSRP session information is added to a Session Description Protocol (SDP), and may be sent to the SS 131. The SS 131 transfers the INVITE message received from the first terminal 15 to the second terminal 13 (S327). Further, the SS 131 transfers a response message (100 Trying), indicating that a connection to the second terminal 13 is being tried, to the first terminal 15 (S329). Such a response message is required to prevent the INVITE message from being retransmitted by the first terminal 15 when a network delay occurs.

If the MSRP session information is accepted by the second terminal 13, the SS 131 receives a response message (200 OK) containing the MSRP session information of the second terminal 13 from the second terminal 13 (S331). Further, the SS 131 forwards the 200 OK message received from the second terminal 13 to the first terminal 15 (S333).

The SS 131 receives an acknowledgement (ACK) message from the first terminal 15 (S335). In response to such an ACK message, the MSRP server 135 connected to the SS 131 is connected to the first terminal 15. The SS 131 sends the ACK message from the first terminal 15 to the second to terminal 13 (S337). When the ACK message is transferred to the second terminal 13, the MSRP server 135 is connected to the second terminal 13. By means of the above-described procedure, a file transfer session passing through the MSRP server 135 is established between the first terminal 15 and the second terminal 13 (S340).

The first terminal 15 loads multimedia content data, such as the corresponding sound source or video file, into an MSRP SEND message depending on the selection of a file transfer menu by the user and sends a resulting MSRP SEND message to the second terminal 13 (S351). If the MSRP SEND message has been successfully received, the MSRP server 135 sends a 200 OK message indicative of successful message reception to the first terminal 15 (S353).

The MSRP server 135 sends an MSRP SEND message to the second terminal 13 (S355). If the MSRP SEND message has been successfully sent to the second terminal 13, the MSRP server 135 receives a 200 OK message, indicating that the corresponding message has been successfully transferred, from the second terminal 13 (S357).

The MSRP server 135 receives an MSRP REPORT message, indicating whether or not the multimedia content data contained in the MSRP SEND message has been successfully received, from the second terminal 13 (S359). If the second terminal 13 has successfully received the multimedia content data, the MSRP server 135 sends an MSRP REPORT message indicative of the results of file transfer, for example, successful file transfer, to the first terminal 15 (S361). Meanwhile, the application of the first terminal 15 determines the results of the file transfer via the MSRP REPORT message received from the MSRP server 135 (S363), and if the results of the file transfer indicate unsuccessful file transfer, asks the user whether to select retransmission (S365). Here, if the user selects retransmission, the application of the first terminal 15 returns to the step immediately before step S351 so as to retransmit the previously selected sound source or video file. In contrast, if the user does not select retransmission, the application terminates the procedure of the service for sharing multimedia content while performing the communication service.

If it is determined at step S363 that the file has been successfully transferred, the SS 131 receives a play direction signal from the first terminal 15 (S367). Such a play direction signal may be implemented in the form of an SIP message in which a play command defined by a predetermined standard is contained in a content field. The SS 131 forwards the play direction signal received from the first terminal 15 to the second terminal 13 (S369). The SS 131 receives a 200 OK message, indicating that the play command has been received, from the second terminal 13 (S371), and transfers the 200 OK message indicating that the second terminal 13 has received the play command to the first terminal 15 (S373). In this case, the SIP message or the play direction signal containing the play command may include time information about time at which the play of the multimedia content is to be started. Such time information enables the first terminal 15 and the second terminal 13 to start playing the corresponding content at the substantially same time. Of course, in another aspect applicable to the present embodiment, the time at which the play of the corresponding content is started may be either the time at which the reception of the SIP message containing the play command is checked, or the time at which the reception of a response message to the SIP message containing the play command is checked.

Through the above-described process, the previously selected multimedia file is played on the first terminal 15 (S375), and together with this, the multimedia file received from the first terminal 15 is played on the second terminal 13 (S377).

After the above-described procedure, the SS 131 may receive a report of the results of file transfer and file play from the first terminal 15 (S379). The results of file transfer and file play may be transmitted in the form of an SIP message in which a report command defined by a predetermined standard is contained in a content field. In this case, the SS 131 may store records related to the report of the results of file transfer and file play received from the first terminal 15, and may send a 200 OK message, indicating that a report message has been received, to the first terminal 15.

If file play has been terminated, the application of the first terminal 15 asks the user whether to repeat the play of the corresponding file (S383). If the user selects repetitive play, the process may return to the step immediately before step S367, thus enabling the procedure ranging from step S367 to be performed again. In contrast, if the user does not select repetitive play or terminates play at step S383, the application of the first terminal 15 sends an SIP BYE message for the file transfer session to the second terminal 13 via the SS 131, and the second terminal 13 releases the file transfer session and sends a 200 OK message to the first terminal 15 via the SS 131 to terminate the file transfer session with the first terminal 15, thus terminating the scenario of the service for sharing multimedia content during the performance of the communication service. Further, if the first terminal 15 terminates the use of the multimedia content sharing service or if a predetermined period of time has elapsed, the application of the second terminal 13 may be operated to automatically delete the multimedia content data temporarily stored in the second terminal 13 (S385).

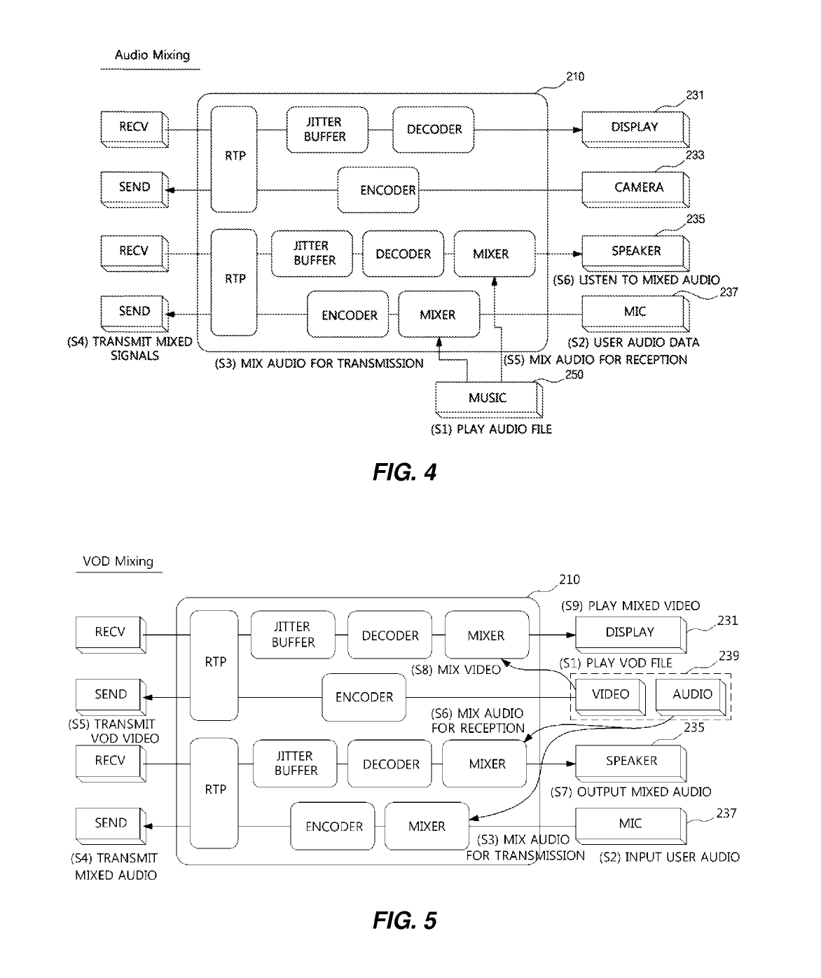

FIGS. 4 and 5 illustrate a method of transmitting a music file or a VOD file, selected by a customer during a video chat between smart terminals over an IP network, to the other party by using an audio or video mixing method performed in the application (hereinafter simply referred to as “App”) of a user terminal. In accordance with the present embodiment, the App of each smart terminal mixes and combines multimedia content and transmits the resulting content to the terminal of the other party. This method corresponds to a scheme for allowing the App of a transmitting terminal to mix audio or video data and transmit mixed data to the other party, rather than a scheme for extracting a specific text keyword from text transmitted or received by each terminal, finding content corresponding to the keyword, and playing the content. Further, in order to use a gift function, or the save function or download function of the other party, the metadata of a sound source file or information about a file selected via interworking with the service provision system of the present embodiment may be transferred to the other party.

FIG. 4 is a block diagram showing a client terminal to describe a music file service provision process employable in the method of FIG. 2.

Referring to FIG. 4, a music file selected by at least one side of user terminals during a video chat between the user terminals may be mixed with the corresponding user's own voice, and may be listened to in real time or transmitted to the other party. That is, if a predetermined music file is selected by the transmitting or receiving user terminal during the video chat between user terminals connected to the multimedia service provision system according to the present embodiment, the corresponding user terminal may transmit the music file mixed using an audio mixing method to the terminal of the other party in real time while playing the mixed music file.

Such a user terminal may be provided with a main body 210 including, for example, at least one Real-time Protocol (RTP) communication interface, at least one jitter buffer, at least one decoder, at least one encoder, and at least one mixer. Further, the user terminal may include a display 231 and a speaker 235 for outputting received video and/or audio data, a camera 233 for capturing external images, a microphone 237 for receiving external audio information, etc.

The process for listening to and transmitting music during a video chat on the user terminal according to the present embodiment will be described in detail below. First, a specific sound source (music) 250 is played on the user terminal (S1). In this case, the sound source 250 includes audio files, such as a song file, background music, or sound effects.

When the sound source 250 is played, and audio data of the user to be transferred to the other party during a video call is input through the microphone 237 (S2), the application of the user terminal mixes the sound source 250 with the audio data of the user through a mixer on the transmitting side (S3), and transfers the mixed audio to the other party who is engaged in the video chat (S4). Further, the application mixes the sound source 250 with audio data received from the terminal of the other party through a mixer on the receiving side (S5), and outputs the mixed audio through the speaker 235 (S6).

In accordance with the present embodiment, the service provision system establishes a file transfer session between the user terminal and the terminal of the other party, relays the transmission/reception of messages between both terminals, and supports the real-time transmission/reception of sound sources desired to be simultaneously listened to by all of participants in the video chat, thus enabling multimedia content to be simultaneously listened to in real time on both the terminals in a streaming manner during the video chat.

FIG. 5 is a block diagram showing a user terminal to describe a VOD file service provision process employable in the method of FIG. 2.

Referring to FIG. 5, during a video chat between transmitting and receiving user terminals, a VOD file selected by at least one user terminal may be played in real time or may be transmitted to the terminal of the other party. That is, during the video chat between smart terminals, if the user of a transmitting or receiving smart terminal selects a predetermined VOD file, the corresponding smart terminal plays VOD video together with audio signals, obtained by mixing the user's audio and/or the audio of the other party with VOD audio, while transmitting in real time the mixed audio signals and the VOD video to the terminal of the other party, thus allowing participants in the video chat to view the VOD file together during the video chat. The reception port RECV and the transmission port SEND of the user terminal are connected to the multimedia service provision system through the network.

A process for playing and transmitting a VOD file during a video chat on a user terminal according to the present embodiment will be described in detail below. First, the user executes a VOD file 260 to be simultaneously viewed together with the other party of a video chat using an application installed on the user terminal (SD.

If the VOD file 260 is executed and the audio data of the user to be transferred to the other party during a video call is input through the microphone 237 (S2), the application of the user terminal mixes the audio of the user with VOD audio through a transmitting side mixer (S3), transfers mixed audio signals to the other party who is engaged in the video chat (S4), and transmits the VOD video of the VOD file 260 to the terminal of the other party (S5). Further, the application mixes the audio of the other party received by the user terminal with the VOD audio using a receiving side mixer (S6), outputs the mixed audio through the speaker 235 (S7), mixes the video received from the terminal of the other party with the VOD video using a receiving side mixer (S8), and plays the mixed video on the display device 231 of the user terminal (S9).

In accordance with the present embodiment, the service provision system establishes a video call session between the user terminal and the terminal of the other party, and supports the real-time transmission/reception of a VOD file desired to be simultaneously listened to by all participants in the video chat, together with the transmission/reception of messages between both the terminals, thus enabling multimedia content to be simultaneously listened to in real time in a streaming manner during the video chat between both the terminals.

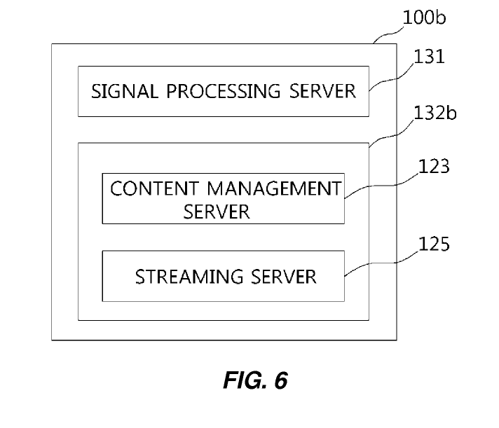

FIG. 6 is a schematic diagram showing another embodiment of a configuration employable in the multimedia content sharing service provision system of FIG. 1.

Referring to FIG. 6, a service provision system 100b includes a signal processing server 131 and a multimedia content relay server 132b. The multimedia content relay server 132b includes a Content Management Server (CMS) 123 and a Streaming Server (STS) 125.

The signal processing server 131 performs a signal processing operation so that multimedia content data may be transmitted to the corresponding terminals in a streaming manner in response to a multimedia content sharing request signal received from a first terminal or a second terminal while performing a communication service. In the present embodiment, the multimedia content sharing request signal includes a multimedia content reception agreement request signal received from the first terminal 15.

For example, the signal processing server 131 processes the multimedia content reception agreement request signal received from the first terminal 15 and a multimedia content reception agreement response signal received from a second terminal 17, and requests the streaming transmission of the multimedia content data from the streaming server 125 in response to the streaming request signal of the first terminal 15.

The content management server 123 receives multimedia content data corresponding to a content identifier included in the streaming request signal from the signal processing server 131 and stores the multimedia content data. The multimedia content data may be provided by an external content provider.

The streaming server 125 transmits the multimedia content data received from the content management server 123 to the first terminal 15 and to the second terminal 17 in a streaming manner at the request of the signal processing server 131.

The service provision system 100b according to the present embodiment may include an MSRP server so as to provide an instant messaging service as a communication service between the first terminal 15 and the second terminal 17.

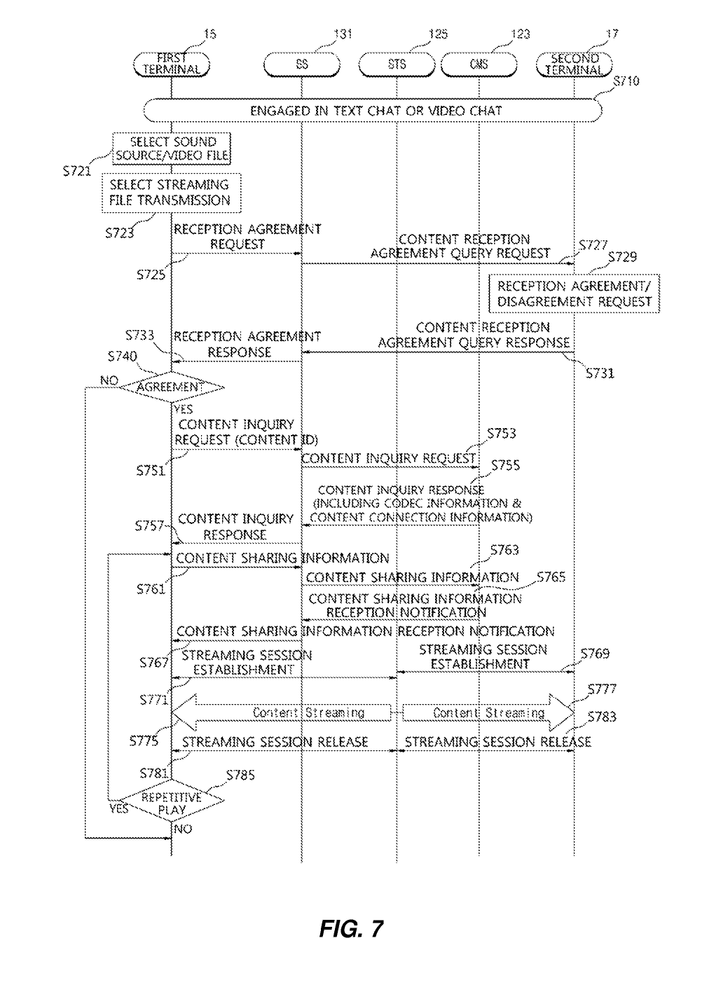

FIG. 7 is a flowchart showing a service procedure for a multimedia content sharing service provision method employable in the multimedia content sharing service provision system of FIG. 6.

As shown in FIG. 7, the multimedia content sharing service provision method is configured such that the service provision system including the signal processing server 131, the content management server 123, and the streaming server 125 allows users to share the corresponding content by providing corresponding multimedia content in a streaming manner in response to a multimedia content sharing request signal received from at least one of user terminals which perform a communication service.

In the present embodiment, the service provision system includes a Signaling Server (SS) 131 as the signal processing server, and includes the content management server 123 and the streaming server 125 as the multimedia content relay server 132b.

The procedure of the multimedia content sharing service provision method according to the present embodiment will be described in detail below.

The user of the first terminal 15 and the user of the second terminal 17 are engaged in the text chat or video chat (S710). In this case, the application of the present embodiment for providing a communication service screen for a text chat or a video chat to the first terminal 15 or the second terminal 17 may provide a text input box, a music menu, a VOD menu, a music/VOD control menu, etc. to be used for the multimedia content sharing service to the communication service screen.

In the state of the text or video chat, a specific keyword of text of the user entered into a chat window through the application installed on the first terminal 15 is recognized, or the selection of the user about the music/VOD menu displayed on the screen of the first terminal 15 is recognized (S721). If user input for the streaming transmission of a file is recognized (S723), the first terminal 15 sends a content reception agreement query request message that queries the second terminal 17 about whether to agree upon the reception of streaming to the SS 131 (S725).

The SS 131 sends the content reception agreement query request message to the second terminal 17, and queries the second terminal 17 about whether to agree upon the reception of streaming (S727). In this case, the content reception agreement query request message may correspond to a multimedia content sharing request signal. When the second terminal 17 agrees upon the streaming reception of multimedia content (S729), the SS 131 receives a content reception agreement query response message containing information about the determination of agreement/disagreement from the second terminal 17 (S731), and transmits the information about the determination of agreement/disagreement of the second terminal 17 to the first terminal 15 (S733). The first terminal 15 checks the agreement/disagreement of the second terminal 17 upon the streaming reception of content, proceeds to a subsequent procedure if agreement has been granted, and terminates the present procedure if agreement has not been granted (S740).

Under the agreement of the second terminal 17, the first terminal 15 transmits a content inquiry request message to the SS 131 (S751). The content inquiry request message is used to inquire about content information using a content identifier (ID). The content information includes codec information and streaming access information related to the corresponding content. The content identifier designates a series of numerals, characters, symbols, or combinations thereof used to identify multimedia content selected by the user of the first terminal 15. The content identifier is preferably set so that the first terminal 15, the second terminal 17, and the service provision system recognize the same multimedia content.

The SS 131 sends a content inquiry request signal requesting content information to the CMS 123 at the request of the first terminal 15 (S753). The CMS 123 transmits a content inquiry response message to the SS 131 (S755). The content inquiry response message includes the codec information of the multimedia content inquired by the SS 131 and the streaming access information. The SS 131 sends the content inquiry response message to the first terminal 15 (S757).

The first terminal 15 that received the content inquiry response message sends a content sharing information transmission request message to the SS 131 (S761). The content sharing information transmission request message is required to transfer content information received in a streaming manner to the second terminal 17, and the content information received in a streaming manner includes the codec information of the corresponding content and streaming access information. The SS 131 transmits content sharing information including the content information to the second terminal 17 (S763).

The second terminal 17 that received the content information sends a content sharing information reception notification message to the SS 131 (S765). The SS 131 sends a content sharing information reception notification message indicating that the second terminal 17 has received the content information to the first terminal 15 (S767).

The second terminal 17 accesses the STS 125 using content streaming access information contained in the content information (S769). The first terminal 15 also accesses the STS 125 using the content streaming access information contained in the content information (S771). By means of this access, streaming sessions are connected between the first terminal 15 and the STS 125 and between the STS 125 and the second terminal 17.

After the connection of the streaming sessions has been completed, the STS 125 starts to transmit the corresponding multimedia content to the first terminal 15 in a streaming manner (S775) and at the substantially same time, starts to transmit the multimedia content to the second terminal 17 in a streaming manner (S777). In this case, the first terminal 15 and the second terminal 17 output video signals and audio signals streamed from the STS 125. The multimedia content data corresponding to the content information may be provided from the CMS 123 to the STS 125.

Once the streaming transmission of the multimedia content is completed, the STS 125 terminates the connection of the streaming sessions with the first terminal 15 and the second terminal 17 (S781, S783). If the connection of the streaming sessions has been terminated, the first terminal 15 or the second terminal 17 outputs video and audio received from the terminal of the other party and makes a video call in the case of a video chat.

The application of the first terminal 15 may ask the user of the first terminal 15 about whether to repeat the play of the multimedia content as the connection of the streaming sessions has been terminated (S785). As the user selects the repetition or termination of play, the application of the first terminal 15 may return to step S761 to repeat a subsequent content sharing procedure or terminate the present service procedure.

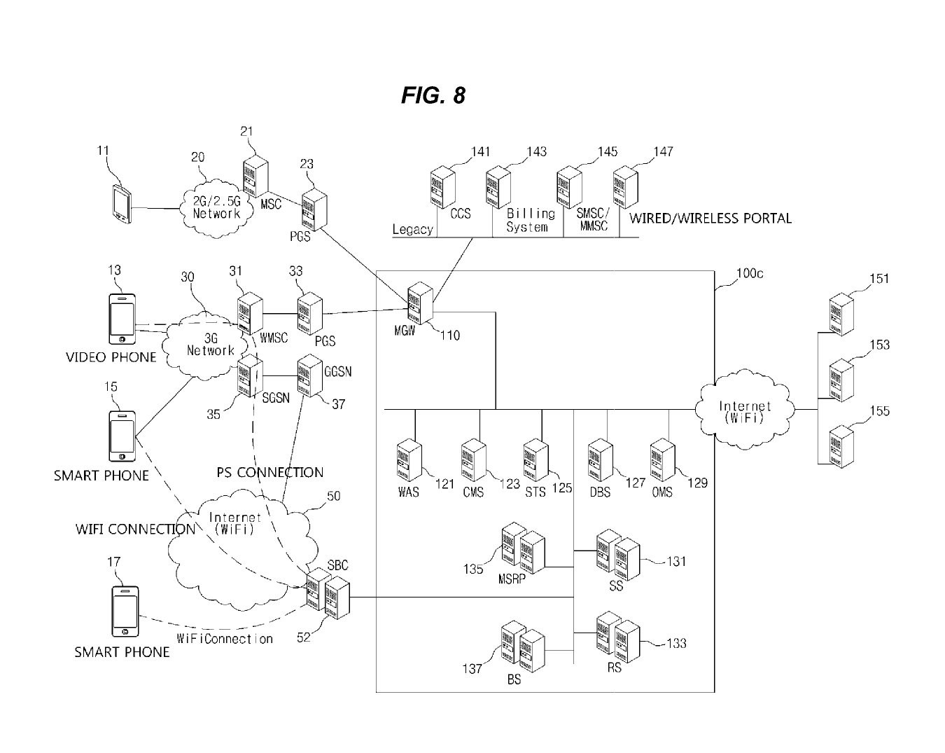

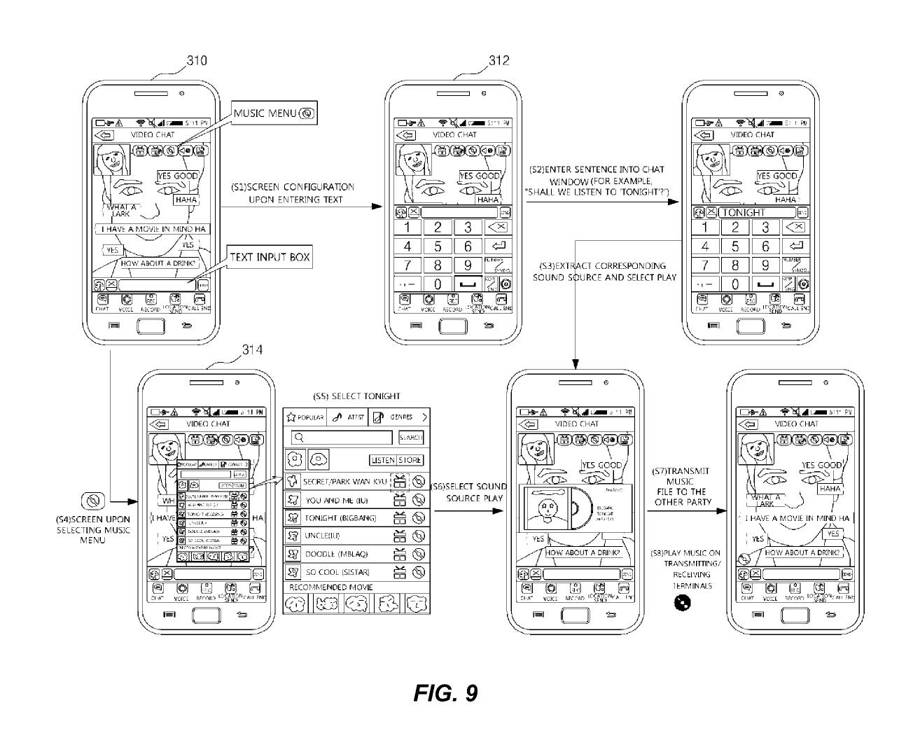

FIG. 8 is a schematic block diagram showing a further embodiment of a configuration employable in the multimedia content sharing service provision system of FIG. 1.

Referring to FIG. 8, a system 100c for providing a multimedia content sharing service includes a Media gateway (MGW) server 110, a Web Application Server (WAS) 121, a Content Management Server (CMS) 123, a Streaming Server (STS) 125, a DB system (DBS) 127, an Operation administration and Management Server (OMS) 129, an SIP signal processing server (SIP signaling server) 131, a Registration Server (RS) 133, a Message Session Relay Protocol (MSRP) server 135, and a billing server (137). Servers taking charge of individual functions in the service provision system 100c designate components or modules for performing functions corresponding thereto, and they may be combined with each other to constitute at least one device.

The MGW 110 denotes a transmission device or a service for converting digital media streams between different telephone networks, for example, some of a Public Switched Telephone Network (PSTN), a Signaling System No. 7 (SS7) network, a 2G/2.5G/3G radio access network, and a Private Branch Exchange (PBX), and enables multimedia communication to be performed over a next-generation network based on a multicast transport protocol, such as Asynchronous Transfer Mode (ATM) or Internet Protocol (IP). That is, the MGW 110 supports voice call matching with a Code Division Multiple Access (CDMA) network or voice call matching with a WCDMA network, and provides the function of converting signaling in a legacy network and call signaling supported by the SS 131, media in Time-Division Multiplexing (TDM), and Real-Time Protocol (RTP) media in the application of the user terminal 11, 13, 15, or 17 and relaying converted media.

In accordance with the service provision system 100c having the MGW 110 according to the present embodiment, a communication service such as a text chat or voice call service may be connected between a voice phone terminal 11 connected to the 2G or 2.5G network and a smart phone 15 or between a video phone terminal 13 and the smart phone 15, and multimedia content such as music or movies may be shared and simultaneously listened to or viewed between the terminals during the performance of the communication service.

The Web Application Server (WAS) 121 processes web business logic.

The Content Management Server (CMS) 123 stores and manages various types of multimedia content, such as sound sources, e-books, music videos (VOD), or movies. Such content may be provided by an external content provider or the like. Further, the CMS 123 provides a platform for portal sites based on external networks, such as Daum (www.daum.net), open markets such as mobile App stores, or clouding systems, and performs the function of working in conjunction with content providers, portal sites, open markets, and clouding systems. In this case, the mobile App stores include T-store of SK Telecom Co., Ltd., Apple's iPhone App Store, Nokia's Ovi Store, Android Market, Blackberry App World, etc.

The STS 125 delivers content selected by a subscriber or a customer to the user terminal in a streaming manner. The STS 125 transmits content corresponding to music, an e-book or a VOD file selected by the customer to the user terminal in real time in streaming manner while working in conjunction with the CMS 123.

The DBS 127 manages DBs for statistical information about voice and video calls, statistical information about services, and statistical information about service management.

The OA&M Server (OMS) 129 is a component for operating and managing the service provision system 100c, and performs functions, such as the system configuration management, statistical processing management, fault processing management, and operation management of the service provision system 100c.

The SIP Signaling Server (SS) 131 processes IMS network-based Session Initiation Protocol (SIP) signaling, and performs an SIP-proxy (S-proxy) function of controlling an SIP session request for an external network. Further, the SS 131 processes the management, statistics, and Call Detail Records (CDR) of SIP calls routed from the IMS network, and performs the function of routing a call to an Application Server (AS) for processing the corresponding SIP call in compliance with an Integrated Services digital network User Part (ISUP) call scenario management guideline. In the present embodiment, the application server may be regarded as being included in the MGW 110. In this case, the IMS network which denotes a set or an architectural framework of nodes for providing an IP multimedia service may include a Call Session Control Function (CSCF), a Home Subscriber Server (HSS), and an application server, and transfer information about a user terminal, in which a predetermined IP multimedia service is set, to the corresponding service provider.

The RS 133 takes charge of the management of a list of phone directories of subscribers, the management of subscribers' states, and the management of subscriber authentication, and interworks with the IMS network based on the SIP.

The MSRP server 135 takes charge of the transmission of instant messages, and also takes charge of the management of transfer sessions of binary files for music, images or video and the reliable transmission of files. The MSRP server 135 may be designated as an MSRP switch server.

The Billing Server (BS) 137 performs the function of charging customers for the multimedia content sharing service in the service provision system 100c and a charging and accounting function upon working in conjunction with other platforms.

Further, the service provision system 100c may work in conjunction with an existing legacy system, which includes a Customer Care System (CCS) 141, a billing system 143, a Short Message Service Center (SMSC)/Multimedia Messaging Service Center (MMSC) 145, and a wired/wireless portal system 147. In this case, the CCS 141 is the customer DB of a communication service provider and is a device for processing functions, such as subscriber authentication, and phone authentication, that is, authentication depending on the types of phones. The billing system 143 is a device used to allow the communication service provider to charge the customers, or to process functions such as charging/deduction and balance inquiry for prepaying customers. The SMSC 145 is a short message processing device for sending short messages received from the user terminal or a supplementary service device to the terminal of the other party, and the MMSC is a multimedia message processing device for sensing multimedia messages from a subscriber terminal or a supplementary service device to a receiving terminal. The wired/wireless portal system 147 is a portal system provided in order for a mobile communication customer to use a wired or wireless Internet service provided by the corresponding mobile communication service provider, and provides the corresponding Internet service to subscribers who subscribed to a predetermined service.

Further, the service provision system 100c may be connected to an external open platform 151, an external platform 153, a content provider 155, etc. over the Internet. In this case, the open platform 151 denotes a platform used by the smart terminals 15 and 17 to download various programs and content as in the case of App store, T-store or Olle Market, or receive a streaming service. The external platform 153 denotes a portal service provider platform or a clouding system platform operated and serviced for pieces of content, and is a platform enabling music, e-books, movies, etc. to be used. Further, the CP 155 denotes a content provider capable of uploading various types of content to the service provision system 100c.

The user terminal and the corresponding network connected to the service provision system 100c according to the present embodiment will be described in greater detail below.

The voice phone terminal 11 is a user terminal for performing voice communication and data communication over a 2G or 2.5G network. The video phone terminal 13 designates a user terminal for performing voice, image/video, and data communication over a WCDMA network. Each of the smart terminals 15 and 17 is configured to perform voice, image/video, and data communication over the Internet, a WiFi network 50, or a WCDMA packet switched (PS) network, and denotes a user terminal provided with a wireless Internet function and equipped with an integrated application (App) for transmitting/receiving character/text messages, transmitting/receiving voice or video messages, and making voice/video calls over the WiFi or PS network Such a smart terminal 15 or 17 includes a so-called smart phone, tablet PC, iPad, etc.

The 2G/2.5G or CDMA (Global System for Mobile Communications: GSM) network 20 interworks with the service provision system 100c via a Mobile Switching Center (MSC) 21 which is the exchange of a mobile communication service provider capable of routing and processing a voice call using a CDMA (GSM) user terminal, and a Protocol Gateway Service (PGS) server 23 which functions as a gateway between an external network and an internal network.

The WCDMA network 30 may route and process a voice call and a video call using a WCDMA terminal, and take charge of interworking between the user terminal of a WCDMA packet switched network and the user terminal of an external network via a Serving GPRS (General Packet Radio Services) Support Node [SGSN] 35 and a Gateway GPRS Support Node (GGSN) 37. Further, the WCDMA network 30 works in conjunction with the service provision system 100c via a WCDMA MSC 31 which is an exchange capable of routing a voice call and a video call to the WCDMA user terminal such as the video phone 13 and processing the calls, and the PGS server 33.

The Internet 50 denotes a global system of mutually connected computer networks which use a series of communication protocols widely known as Transmission Control Protocol/Internet Protocol (TCP/IP) or User Datagram Protocol/Internet Protocol (UDP/IP). The user terminal may access the Internet 50 in a wireless LAN manner, such as a WiFi network. Further, the Internet 50 is connected to the service provision system 100c through a Session Border Controller (SBC) 52. The SBC 52 is a component following industrial standards provided by the SIP network, and processes a Network Access Translation (NAT) traversal that may occur between the SIPs of computer networks which access the Internet 50 and are connected to each other.

In accordance with the service provision system 100c of the present embodiment, the multimedia content sharing service may be provided via the application of the user terminal during the performance of a communication service. Further, the service may be provided so that users who are engaged in the corresponding communication service share multimedia content in real time in response to a multimedia content sharing request signal from the user terminal during the performance of the communication service.

FIG. 9 is a conceptual diagram showing an embodiment of the interworking procedure of a user terminal employable in the service provision system and method according to an embodiment of the present invention.

Referring to FIG. 9, a user terminal 310 shares multimedia content with the other party of a video chat using a preset method, for example, a method such as that shown in FIG. 3, depending on a video chatting option set by the user or a multimedia content sharing service option during the video chat. In this case, on the user terminal 310, an application for supporting a multimedia content sharing service during a video chat and providing the corresponding service screen is installed.

A procedure for executing the application on the user terminal according to the present embodiment will be described in detail below.

First, the application provides a video chat screen and a multimedia content sharing menu displayed in a partial area of the video chat screen to the display of the user terminal 310. The multimedia content sharing menu may include icons (music menu) for allowing the user to select music during the video chat, an input interface (hereafter referred to as a ‘chat window’) for entering characters or text for chatting, etc. On the screen of the user terminal 310, the user may select a music menu displayed on the screen or enter a predetermined keyword into the chat window while performing the communication service.

When the user opens the chat window (S1), a keypad is displayed on the screen (312). If the user enters text related to a song, such as a singer name or a composer name, using a keypad, for example, the sentence “Shall we listen to Tonight?” (S2), a character recognition engine installed on the application of the user terminal recognizes a specific keyword, for example, the song title ‘tonight’ contained in chatting text. As the user selects the play of the corresponding sound source displayed on the screen (S3), the application requests a sharing service for the corresponding sound source file from the service provision system.

Meanwhile, when the user selects a music menu (S4), a sound source list is displayed on the user terminal (314). If a desired sound source, for example, ‘tonight’ is selected by the user (S5), the application requests the multimedia content sharing service from the service provision system depending on the selection of the user on the play of the corresponding sound source (S6).

According to step S3 or S6, the service provision system receives a multimedia content sharing request signal from the application of the user terminal 310. In this case, the multimedia content sharing request signal corresponds to either a signal requesting the service provision system to transmit a multimedia data file corresponding to multimedia content stored in the user terminal to the terminal of the other party based on the keyword recognized by the character recognition engine, or a signal requesting the service provision system to transmit multimedia content corresponding to the identifier of the multimedia content stored in the user terminal in a streaming manner while transmitting the identifier to the service provision system in accordance with the keyword recognized by the character recognition engine. Such a multimedia content sharing request signal may be generated by the user terminal 310 in the form of an INVITE message, in which MSRP session information is added to a Session Description Protocol (SDP), and may be sent to the signal processing server provided in the service provision system.

Further, the service provision system may transmit the multimedia file of the user terminal to the terminal of the other party through a file transfer session established between the terminals of the users who are performing a communication service in response to the multimedia content sharing request signal, or transmit a multimedia file corresponding to the identifier of multimedia content, for example, a music file, to both user terminals in a streaming manner in response to a multimedia content sharing request signal and a streaming request signal (S7).

If the predetermined sound source is transferred from the user terminal 310 to the terminal of the other party, or if the corresponding sound source is transferred from the service provision system to the user terminal 310 and the terminal of the other party in a streaming manner, users who are engaged in the communication service may listen to the same music together during the performance of the communication service (S8).

In addition to the above-described service procedure, the service provision system and method according to the present embodiment may include various supplementary service procedures. For example, the application installed on the user terminal or the service provision system connected to the user terminal may present multimedia content, such as music currently being played on the user terminal, as a gift to the other party or a third party using a gift function, or may allow at least one of the users who are engaged in the communication service to immediately purchase the corresponding content using the function of setting the content as his or her own, a download function, etc. Further, the application of the user terminal or the service provision system may provide functions allowing the terminals of the user and/or the other party to control pause, replay, and stop operations, on the multimedia content, e.g., music being played on both the terminals.

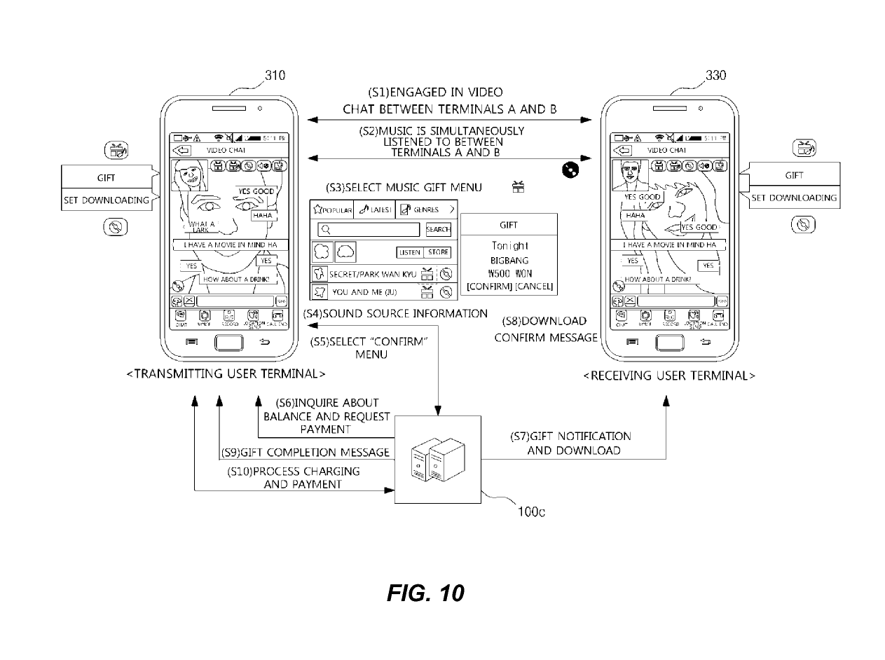

FIG. 10 is a conceptual diagram showing a gift supplementary service procedure during the performance of a multimedia content sharing service, employable in the service provision system and method, according to an embodiment of the present invention.

Referring to FIG. 10, when the users of a transmitting user terminal 310 and a receiving user terminal 330 are simultaneously listening to music selected by the user of, for example, the transmitting terminal 310, while engaged in a video chat, the user of the transmitting terminal 310 may present the corresponding sound source as a gift to the other party by selecting a gift menu button provided by an application installed on his or her terminal (hereinafter referred to as a ‘first App’).

The procedure of the gift supplementary service according to the present embodiment will be described in detail below. For example, the user of the transmitting terminal 310 in the state S1 of being engaged in the video chat requests the user of the receiving terminal 330 to share a music file corresponding to his or her own sound source. In a state S2 in which the users simultaneously listen to the corresponding music as background music, the user of the transmitting terminal 310 selects a gift menu on the first App (S3).

In this case, the first App may transfer an information request signal for the corresponding sound source to the service provision system 100c as the user selects the gift menu, and may receive information about the corresponding sound source from the service provision system 100c. After receiving the corresponding sound source information from the service provision system 100c, the first App may check the sound source information displayed on the screen of the transmitting terminal 310 and select a ‘confirm’ menu (S5). This procedure may be omitted when the sound source information is present in the transmitting terminal 310. The service provision system 100c may include the SS 131, the RS 133, the MSRP server 135, the BS 137, the STS 125, and the CMS 123 of FIG. 8 so as to provide the supplementary service of the present embodiment.

When the user of the transmitting terminal 310 selects a ‘confirm’ menu for ‘gift’ on the screen (S5), the first App inquires about the balance of the transmitting user terminal 310 and requests the transmitting user terminal to pay for the corresponding sound source while working in conjunction with the service provision system 100c connected over the network (S6). This payment procedure may be omitted when the corresponding sound source is free.

As the user of the transmitting terminal 310 requests payment, the service provision system 100c sends a notification message, indicating that the user of the transmitting terminal 310 desires to present a sound source as a gift, to the user of the receiving terminal 330. If the user of the receiving terminal 330 confirms the downloading, the downloading of the corresponding sound source to the receiving terminal 330 may be accepted (S7). If the downloading of the sound source to the receiving terminal 330 has been completed, the service provision system 100c may receive a download completion message from the receiving terminal 330 (S8).

If the downloading of the sound source to the receiving terminal 330 has been completed, the service provision system 100c sends a gift completion message to the transmitting terminal 310 (S9). Further, the service provision system 100c processes charging and payment of the transmitting terminal 310 while working in conjunction with the first App (S 10).

In the present embodiment, although a case where the transmitting terminal 310 selects the function of a gift supplementary service has been described by way example, it is apparent that, when a streaming-type multimedia content sharing service is used, a gift supplementary service function may also be used even by the receiving terminal 330.

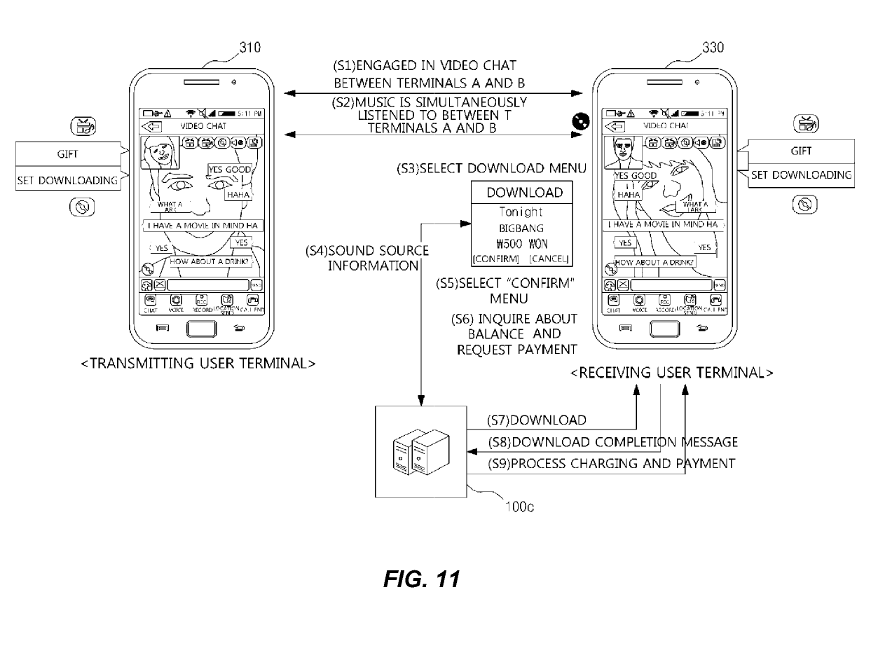

FIG. 11 is a schematic conceptual diagram showing a download supplementary service procedure employable in the system and method according to an embodiment of the present invention.

Referring to FIG. 11, in a state in which the users of the transmitting terminal 310 and the receiving terminal 330 are engaged in the video chat, when they are simultaneously listening to music selected by, for example, the user of the transmitting terminal 310, the user of the receiving terminal 330 may select a download menu button provided by an application installed on his or her terminal (hereinafter referred to as a “second App”), and then download and store the corresponding sound source to and in his or her terminal.

The download supplementary service procedure according to the present embodiment will be described in greater detail below. First, in a state S2 in which the user of the transmitting terminal 310 which is engaged in a video chat (S1) requests the other party of the chat, who is the user of the receiving terminal 330, to share a predetermined music file, and the users are simultaneously listening to the corresponding music as background music, the user of the receiving terminal 330 selects a download menu displayed on the screen provided by the second App (S3).

When information about the corresponding sound source is present in the receiving terminal 330, the second App may display the sound source information on the screen of its own terminal. In contrast, if the corresponding sound source information is not present in the receiving terminal 330, the second App may request and receive sound source information from the service provision system 100c (S4). The user of the receiving terminal 330 confirms the sound source information displayed on the screen.

When the user of the receiving terminal 330 selects a ‘confirm’ menu for the download supplementary service (S5), the second App inquires about the balance of the receiving terminal 330 and requests the receiving terminal 330 to pay for the corresponding sound source while working in conjunction with the service provision system 100c (S6). This payment procedure may be omitted when the corresponding sound source is free. Once the payment is completed, the service provision system 100c provides the downloading of the sound source to the receiving terminal 330 (S7).

If the downloading has been completed, the service provision system 100c receives a download completion message from the receiving terminal 330 (S8), and processes charging and payment for the corresponding sound source while working in conjunction with the second App (S9) of the receiving terminal.

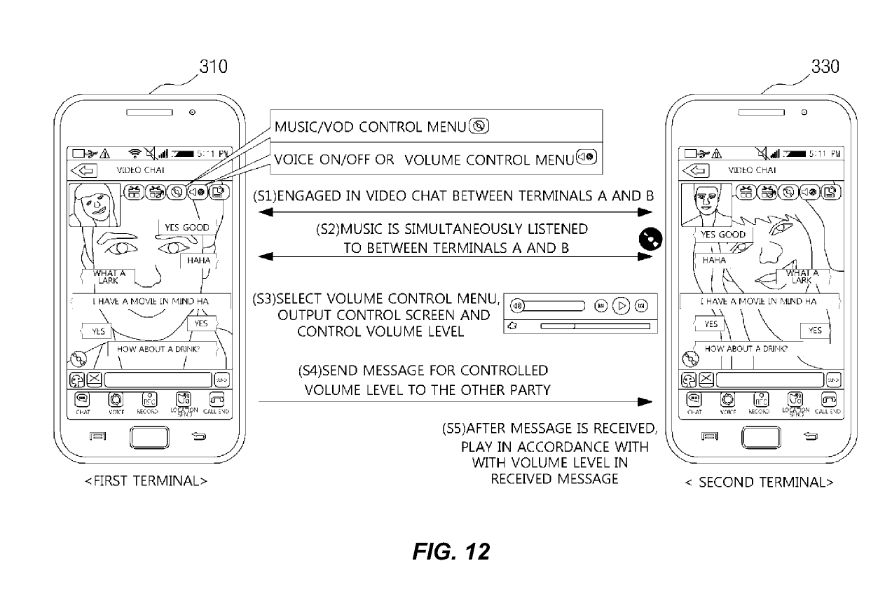

FIG. 12 is a conceptual diagram showing another embodiment of a multimedia sharing service employable in the system and method according to an embodiment of the present invention.

As shown in FIG. 12, the service provision system according to the present embodiment provides a service so that, when the users of the first terminal 310 and the second terminal 330 are simultaneously listening to music (S2) in the state S1 of being engaged in a video chat, the music play environments of first terminal 310 and the second terminal 330 may be shared. That is, the service may be provided so that the user of the first terminal 310 corresponding to a host side may control the corresponding content executed on the second terminal 330 corresponding to a remote side using the music/VOD control menu of the application installed on his or her own terminal.

For example, the user of the first terminal 310 controls the volume of the corresponding music file by selecting an audio or volume menu on his or her terminal (S3). As the volume of the first terminal 310 is controlled by the user, the first App transmits a controlled volume level to the second terminal 330 through the service provision system (S4). Here, a volume control method may be a method by which, in the case of a streaming transmission form, the service provision system controls the volume of the corresponding content depending on the volume level controlled by the first terminal 310 and transmits the volume level to the second terminal 330, or a method by which, in the case of a file transfer form, the volume level of the corresponding sound source is transmitted to the second terminal 330 in the form of a message through the service provision system.

The App of the second terminal 330 controls the volume of the corresponding music in conformity with the volume level received from the first terminal 310 and then plays the music (S5). Here, the App of the second terminal 330 immediately plays a streaming sound source when the streaming sound source is received, and controls the volume of a sound source in accordance with a received volume level and then plays the corresponding music when a message for the volume level is received.

The supplementary service according to the present embodiment may be applied in such a way that, when a multimedia file is played on the first terminal during the service procedure of FIG. 3 (S375) and, substantially simultaneously with this, the multimedia file received from the first terminal is played on the second terminal (S377), the service provision system receives a multimedia content play control signal from the first terminal 310 and sends the multimedia content play control signal to the second terminal 330. Further, the supplementary service of the present embodiment may be applied even when performing steps S775 and S777 during the service procedure of FIG. 7.

In this case, a control interface for generating the multimedia content play control signal may be implemented to be activated when at least one of menu items provided by the application of the first terminal 310 is selected. The control interface may include an audio player, a VOD player, etc.

The multimedia content play control signal includes play control signals, sound control signals, etc., wherein the play control signals may include control signals required for play, stop, repetitive play, forward movement, backward movement, etc., and the sound control signals may include control signals required for volume-up, volume-down, and mute.

For example, the multimedia content play control signal may include a music/VOD control menu (hereinafter simply referred to as a ‘music control menu’), and the music control menu may include an operation control menu, such as ON/OFF, stop, pause, replay, fast forward (RWD), rewind (REW), and repetitive play, and a state indication menu, such as running time and elapsed time displayed on the screen, together with the operation control menu.

In accordance with the above configuration, the application of the second terminal 330 automatically performs control, related to the play of the multimedia content currently being played, in response to the multimedia content play control signal received from the first terminal 310.

In the present embodiment, although a case when the volume of music that is simultaneously listened to is controlled by the first terminal 310 has been described by way of example, it is apparent that the volume of the corresponding music may also be controlled by the second terminal 330. In the present embodiment, the first terminal 310 may be a user terminal on a transmitting side or a receiving side.

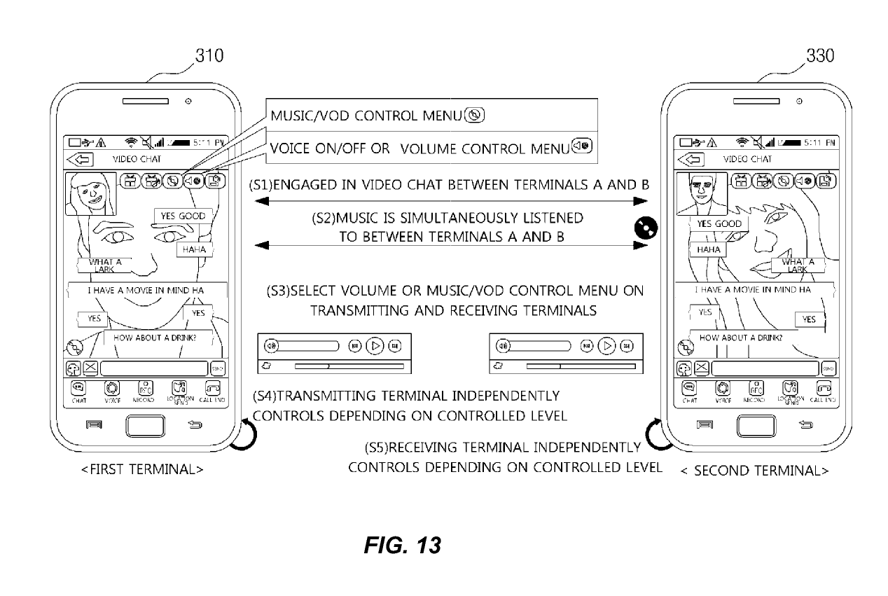

FIG. 13 is a conceptual diagram showing a further embodiment of a multimedia sharing service employable in the system and method according to an embodiment of the present invention.

Referring to FIG. 13, a method of providing a multimedia sharing service according to the present embodiment is another embodiment of a method of remotely controlling multimedia content, wherein in a state in which the users of a first terminal 310 and a second terminal 330 are simultaneously listening to music while engaged in a video chat, a service is provided such that each of the user terminals may adjust the multimedia content by independently selecting an operation control menu enabling the control of volume and the control (Stop/Pause/Replay/FWD/REW) of corresponding content, and repetitive play of the content, and a state indication menu enabling the running time and elapsed time to be viewed, based on the music/VOD control menu in the application installed in each terminal.

For example, in a video chatting state (S1), when the user of the first terminal 310 and the user of the second terminal 330 are simultaneously listening to music as background music (S2), the user of the first terminal 310 selects the music control menu displayed on the screen of his or her terminal for the corresponding content (S3), and then controls items, such as volume and voice on/off, to desired values (S4). Further, similarly to the case of the first terminal 310, the user of the second terminal 330 also selects the music control menu for the corresponding music content (S3), and controls items, such as volume, voice on/off, Stop/Pause/Replay/FWD/REW, or repetitive play, to desired values (S5).

In this case, the service provision system may transfer information about the music control menu items set or changed by a first user on any one side to the other party, and a second user on the other side may personally control the setting the corresponding music content while referring to the music control menu of the second user based on the set or changed items.

In accordance with the present embodiment, the play environment of the corresponding sharing content is controlled based on values directly adjusted by each terminal using the application installed in each of the transmitting and receiving terminals rather than using a host-remote control method, thus allowing the users to share the content in accordance with the their personalities or preferences and consequently improving the user's convenience.

The technical features of the present invention in accordance with the above-described embodiments will be schematically described below.

First, a customer who subscribes to the present service may simultaneously listen to or view the corresponding content together with another party by selecting music such as an MP3 file, a VOD file, or a movie from the menu provided by a predetermined application installed on his or her own user terminal or may listen to or view the corresponding content together with another party by selecting desired music, movie, or the like from the corresponding multimedia content menu when the menu is automatically displayed for specific text that is entered in real time, while using a communication service, such as a real-time text chat or video chat service.

Second, while simultaneously listening to, watching or viewing music, a VOD file, or an e-book when engaged in a communication service, a user may present the content that is currently being played as a gift to another party or a third party or may download the content to his or her own terminal and purchase the content by clicking or touching and selecting the content on his or her own terminal Utilizing such a gift or purchase function may be useful for business collaboration, such as by creating profits with a content provider or other industries. For example, the user of a transmitting or receiving terminal may present a sound source currently being played as a gift to another party who does not have the ownership of content corresponding to the sound source while engaged in a communication service, and the other party may personally purchase the content.

Third, while a real-time simultaneous listening or viewing service is being used when engaged in a communication service, a payment service for a gift or purchase of the corresponding content may be conveniently provided using an application that works in conjunction with the service provision system. Payment services may include a micro-payment service using mobile phone numbers, a payment service based on interworking with streaming services or sound source upload/download services that use interworking with existing music or movie sites or clouding systems, and an online payment service based on interworking with portal sites or open markets.

Forth, when a communication service between a smart terminal and a terminal connected to an existing legacy network is performed, a seamless or smooth multimedia content sharing service may be provided regardless of the type of network to which user terminals are connected.

Fifth, when a real-time text chat, a voice call, or a video chat is performed, an application to installed on a user terminal and configured to provide the screen of the corresponding communication service may allow users who are engaged in a communication service to simultaneously listen to or view multimedia content, such as background music, a VOD file, or a movie which is generated in accordance with a specific menu when the user selects the specific menu, or which is generated in accordance with a specific keyword when the user enters the specific keyword into a chat window provided by the application.

Sixth, a control interface for the corresponding multimedia content is provided to at least one of users who use the multimedia content sharing service when engaged in a communication service, so that the play environment of the corresponding content can be conveniently adjusted, and thus the multimedia content sharing service can be conveniently used thanks to such convenient adjustment.

Although the present invention has been described with reference to the preferred embodiments, the present invention is not limited to the above embodiments, and those skilled in the art to which the present invention pertains may implement various modifications and changes from the above description. Therefore, the present invention should be interpreted with reference to the entire disclosure including the accompanying claims and the attached drawings, and it should be understood that all equal or equivalent modifications belong to the spirit and scope of the present invention.

1. A method of providing a multimedia content sharing service, the method being configured such that a service provision system for providing a communication service between a first terminal and a second terminal provides a multimedia content sharing service to the first terminal and the second terminal while performing a communication service, comprising:
a first step of receiving a signal requesting sharing of multimedia content with the second terminal from the first terminal while performing a communication service;
a second step of establishing a session for transfer of multimedia content between the first to terminal and the second terminal in response to the multimedia content sharing request signal;
a third step of receiving multimedia content data corresponding to multimedia content transmitted from the first terminal and transmitting the multimedia content data to the second terminal;
a fourth step of receiving a play direction signal directing play of the multimedia content from the first terminal and transmitting the play direction signal to the second terminal; and
a fifth step of receiving a response signal to the play direction signal from the second terminal and transferring the response signal to the first terminal,
wherein the first terminal and the second terminal play the multimedia content in response to the play direction signal.

2. The method of claim 1, wherein at the first step, the multimedia content sharing request signal is generated when multimedia content included in a menu page provided by an interface of a communication service of the first terminal is selected by the first terminal.

3. The method of claim 1, wherein at the first step, the multimedia content sharing request signal is generated when multimedia content retrieved based on text data input from the first terminal is selected by the first terminal while the communication service is performed.

4. The method of claim 1, wherein the play direction signal includes information about time at which play of the multimedia content is to be started, and the first terminal and the second terminal simultaneously and individually play the multimedia content at a time corresponding to the time information.

5. The method of claim 1, wherein the second terminal starts to play the multimedia content in response to reception of the play direction signal at the fourth step, and the first terminal starts to play the multimedia content in response to reception of a response signal to the play direction signal at the fifth step.

6. The method of claim 1, further comprising, after the fifth step, a sixth step of receiving a multimedia content play control signal from the first terminal and transmitting the multimedia content play control signal to the second terminal,
wherein the second terminal performs control related to play of the multimedia content in response to the multimedia content play control signal.

7. The method of claim 6, wherein the multimedia content play control signal is a control signal required to control at least one of play, stop, repetitive play, forward movement, backward movement, and volume level control operations of the multimedia content.

8. The method of claim 1, wherein the third step comprises receiving a Message Session Relay Protocol (MSRP) SEND message containing the multimedia content data from the first terminal and sending the MSRP SEND message to the second terminal.

9. The method of claim 8, wherein the fourth step comprises sending a Session Initiation Protocol (SIP) message containing a play command for the multimedia content data to the second terminal.

10. A system for providing a multimedia content sharing service, the system being a service provision system for providing a communication service between a first terminal and a second terminal and providing the multimedia content sharing service to the first terminal and the second terminal while performing a communication service, comprising:
a signal processing server for receiving a signal requesting sharing of multimedia content with the second terminal from the first terminal while performing a communication service, and for establishing a session for transfer of multimedia content between the first terminal and the second terminal in response to the multimedia content sharing request signal; and
a multimedia content relay server for receiving multimedia content data corresponding to the multimedia content transmitted from the first terminal, and transmitting the multimedia content data to the second terminal,
wherein the signal processing server receives a play direction signal directing play of the multimedia content from the first terminal, transmits the play direction signal to the second terminal, receives a response signal acknowledging reception of the play direction signal from the second terminal, and transmits the response signal to the first terminal, and
wherein the first terminal and the second terminal play the multimedia content in response to the play direction signal.

11. A method of providing a multimedia content sharing service, the method being configured such that a service provision system for providing a communication service between a first terminal and a second terminal provides a multimedia content sharing service to the first terminal and the second terminal while performing a communication service, comprising:
a first step of receiving a signal requesting sharing of multimedia content with a second terminal from a first terminal while performing a communication service;
a second step of transmitting a signal, required to determine whether to share multimedia content, to the second terminal in response to the multimedia content sharing request signal, receiving a response signal to the transmitted signal, and transferring the response signal to the first terminal;
a third step of receiving identification information of multimedia content desired to be played and a content sharing information transmission request signal from the first terminal;
a fourth step of extracting multimedia content connection information corresponding to the content identification information and transmitting the multimedia content connection information to the second terminal; and
a fifth step of transmitting the multimedia content to the first terminal and the second terminal connected to each other based on the multimedia content connection information in a streaming manner.

12. The method of claim 11, wherein at the first step, the multimedia content sharing request signal is generated when multimedia content included in a menu page provided by an interface of a communication service of the first terminal is selected by the first terminal.

13. The method of claim 11, wherein at the first step, the multimedia content sharing request signal is generated when multimedia content retrieved based on text data input from the first terminal is selected by the first terminal while the communication service is performed.

14. The method of claim 11, wherein at the first step, the multimedia content sharing request signal includes a request message querying the second terminal about whether to receive the multimedia content in a streaming manner.

15. The method of claim 11, further comprising, after the fifth step, receiving a gift request signal requesting another party or a third party to transmit the multimedia content from at least one of the first terminal and the second terminal and transmitting the multimedia content to the other party or the third party depending on payment made by at least one of the first terminal and the second terminal.

16. The method of claim 11, further comprising, after the fifth step, receiving a download request signal required to download the multimedia content to its own terminal from at least one of the first terminal and the second terminal, and transmitting the multimedia content to the corresponding terminal depending on payment made by at least one of the first terminal and the second terminal.

17. The method of claim 11, further comprising, after the fifth step, receiving a multimedia content play control signal from any one of the first terminal and the second terminal and transmitting the multimedia content play control signal to a remaining one of the first terminal and the second terminal,
wherein the remaining one of the first terminal and the second terminal performs control related to play of the multimedia content in response to the multimedia content play control signal.

18. The method of claim 17, wherein the multimedia content play control signal is a control signal required to control at least one of play, stop, repetitive play, forward movement, backward movement, and volume level control operations of the multimedia content.

19. A system for providing a multimedia content sharing service, the system being a service provision system for providing a communication service between a first terminal and a second terminal and providing the multimedia content sharing service to the first terminal and the second terminal while performing a communication service, comprising:
a signal processing server for, as a signal requesting sharing of multimedia content with the second terminal is received from the first terminal while performing a communication service, transmitting a signal required to determine whether to share multimedia content to the second terminal, receiving a response signal to the transmitted signal, transmitting the response signal to the first terminal, and receiving identification information of multimedia content desired to be played and a multimedia content play request signal from the first terminal;
a content management server for extracting multimedia content data corresponding to the identification information at a request of the signal processing server; and
a streaming server for transmitting the multimedia content data received from the content management server to the first terminal and the second terminal in a streaming manner at a request of the signal processing server.

20. A method of providing a multimedia content sharing service, the method being configured such that at least one of a first terminal and a second terminal provides multimedia content while performing a communication service between the first terminal and the second terminal, via a service provision system for providing a communication service including a real-time text or video chat service, comprising:
a first step of automatically detecting a preset keyword in real time from messages sent/received through a text chat or a video chat on a user terminal while performing a communication service;
a second step of automatically extracting multimedia content data corresponding to the keyword in real time; and
a third step of transmitting video data obtained by mixing or overlaying the multimedia content data with or on signals of the text chat or the video chat to a terminal of another party engaged in the text chat or the video chat.

21. A method of providing a multimedia content sharing service, the method being configured such that at least one of a first terminal and a second terminal provides multimedia content while performing a communication service between the first terminal and the second terminal, via a service provision system for providing a communication service including a real-time text or video chat service, comprising:
a first step of automatically detecting a preset keyword in real time from messages sent/received through a text chat or a video chat on a user terminal while performing a communication service;
a second step of transmitting signals of the text chat or the video chat and the keyword to a terminal of another party engaged in the text chat or the video chat in real time; and
a third step of allowing the terminal of the other party to extract multimedia content data corresponding to the keyword, and displaying video data, obtained by mixing the extracted multimedia content data with the text chat or video chat signals, on a screen.

22. A method of providing a multimedia content sharing service, the method being configured such that at least one of a first terminal and a second terminal provides multimedia content while performing a communication service between the first terminal and the second terminal, via a service provision system for providing a communication service including a real-time text or video chat service, comprising:
a first step of playing a specific sound source or a Video On Demand (VOD) file on a user terminal while performing a communication service;
a second step of mixing audio data of the sound source or the VOD file at the first step with audio data of a user input through a microphone of the user terminal; and
a third step of transmitting mixed audio signals to a terminal of another party engaged in the communication service,
wherein the user terminal mixes the audio data of the sound source or the VOD file with audio data received from the terminal of the other party and outputs mixed audio data through a speaker, and the terminal of the other party outputs mixed audio signals received from the user terminal through a speaker.
